(19) United States
(12) Patent Application Publication
(10) Pub. No.: US 2010/0235210 A1
(43) Pub. Date: Sep. 16, 2010

(54) SCHEDULED DELIVERY SERVICE SYSTEMS, APPARATUSES, METHODS, AND COMPUTER PROGRAMS EMBODIED ON COMPUTER-READABLE MEDIA

(75) Inventor: Edward J. Nadrotowicz, JR., Woodstock, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: United Parcel Service of America, Inc.

(21) Appl. No.: 12/402,145

(22) Filed: Mar. 11, 2009

(51) Int. Cl. G06Q 10/00; G01C 21/00; G06Q 50/00; G06F 19/00

(52) U.S. Cl. 705/8; 701/201; 701/118

(57) ABSTRACT

A system that enables a carrier to provide scheduled delivery service to a consignee is provided. The disclosed system allows the carrier to receive a consignee order from a consignor, determine whether scheduled delivery service is available, and, if scheduled delivery service is available, determine time windows from which the consignee may select for scheduled delivery. Scheduled delivery service may be available if the consignee delivery address is located within an area in which signature is required for delivery, there is a high frequency of failed delivery attempts, or there is a high frequency of inclement weather or traffic congestion/accidents, among other factors. The carrier may determine time windows from which a consignee may select based on the frequency of failed delivery attempts, inclement weather, and/or traffic congestion/accidents in the area surrounding or leading to the consignee delivery address, among other factors.

### BACKGROUND OF THE INVENTION

1. Technical Field. This invention relates to a system, apparatus, method, and computer program embodied on a computer-readable medium for delivering items to consignees based on scheduled delivery time windows selected by the consignees. The invention is applicable to the package delivery industry, as well as other shipping-, delivery-, and transportation-related industries.

2. Description of Related Art

With the continual development and introduction of new computing and communications technology, consignees are demanding improved levels of service, increased options, and more service offerings, in regard to shipping and delivery services. Consignees desire speed, convenience, accuracy, and personal service.

In response to consignee needs, shipping carriers and delivery services (referred to collectively as “carriers”) have developed new and improved service offerings, including overnight shipping, tracking of packages, and scheduled delivery services.

One problem faced by package delivery carriers in attempting to provide efficient delivery service to consignees occurs when the level of service prevents the carrier from leaving a package when no person is present to receive it, or requires a signature. Unsuccessful initial or repeat delivery attempts add significantly to the cost of delivering the package.

Scheduling a delivery at a specific time or within a time window can result in fewer delivery attempts. In regard to scheduled delivery service, past carrier systems sometimes have considered the cost of the service in determining whether or when to offer scheduled delivery service to a consignee. Additionally, carriers have determined whether to offer scheduled delivery service during certain time periods based on whether the number of scheduled deliveries to an area during those certain time periods did not exceed a defined threshold. Other factors have been also considered by carriers. However, these approaches may require complex systems, in the case of cost-based offerings, or add their own cost by requiring an inefficient route in order to reach all addresses allocated to a particular time window.

Accordingly, it may be desirable to develop a system and method by which a carrier may determine whether to offer scheduled delivery service to a consignee that addresses at least some of issues and drawbacks associated with the prior art.

### BRIEF SUMMARY OF THE INVENTION

The following summary is not an extensive overview and is not intended to identify key or critical elements of the apparatuses, methods, systems, processes, and the like, or to delineate the scope of such elements. This Summary provides a conceptual introduction in a simplified form as a prelude to the more-detailed description that follows.

Embodiments of the present invention provide an improvement by, among other things, providing a scheduled delivery service system that may be configured to provide one or more of the following advantages: (1) increase the number of deliveries completed on the first delivery attempt, (2) reduce the overall number of delivery attempts, (3) reduce overall delivery costs in accordance with a reduction in re-delivery attempts, and (4) provide an improved customer service experience for consignees and consignors.

In one embodiment of the present invention, an apparatus for providing scheduled delivery service to consignee is provided. The apparatus may include a processor configured to receive, by electronic data communication over a network, consignee order information from a consignee order file stored in a memory device, in which the consignee order information includes at least a consignee delivery address; retrieve, from a carrier data storage device, scheduled delivery service rules used to determine whether scheduled delivery service is available to a consignee delivery address; and determine if scheduled delivery service is available to the consignee delivery address, based at least in part on one or more of the scheduled delivery service rules selected from the group consisting of frequency of failed delivery attempts rules, driver release rules, traffic congestion information rules, traffic accident rules, inclement weather rules, visiting dignitary rules, announced road construction rules, signature required rules, and number of left turns rules. Additionally, the scheduled delivery service rules may relate to historical delivery data and/or conditions or delivery conditions likely to occur when or continue until the delivery will be scheduled (referred to herein as “current delivery data or conditions”). Furthermore, the processor may be further configured to retrieve, from a carrier data storage device, upon determining that scheduled delivery service is available to the consignee delivery address, time window factors that are used to determine one or more time windows in which scheduled delivery service is available to the consignee delivery address; determine one or more time windows in which the delivery can be scheduled, based at least in part on one or more of the time window factors selected from the group consisting of historical frequency of deliveries, traffic congestion information, traffic accidents, inclement weather, visiting dignitaries, and announced road construction; store, in the carrier data storage device, the one or more time windows in which the delivery can be scheduled; provide to the consignor, by electronic data communication over a network, the one or more time windows in which the delivery can be scheduled; receive an indication from the consignor, by electronic data communication over the network, in which the indication includes a consignee selection of one of the one or more time windows; and store, in the carrier data storage device, the consignee selection of one of the one or more time windows.

In another embodiment, a method for providing scheduled delivery service to consignee is provided. The method may include the steps of receiving by an apparatus, by electronic data communication over a network, consignee order information from a consignee order file stored in a memory device, in which the consignee order information included at least a consignee delivery address; retrieving by the apparatus, from a carrier data storage device, scheduled delivery service rules used to determine whether scheduled delivery service is available to a consignee delivery address; and determining by the apparatus if scheduled delivery service is available to the consignee delivery address, based at least in part on one or more of the scheduled delivery service rules selected from the group consisting of frequency of failed delivery attempts rules, driver release rules, traffic congestion information rules, traffic accident rules, inclement weather rules, visiting dignitary rules, announced road construction rules, signature required rules, and number of left turns rules. Additionally, the scheduled delivery service rules may relate to historical and/or current delivery data and/or conditions. Furthermore, the method may further include the steps of retrieving by the apparatus, from a carrier data storage device, upon determining that scheduled delivery service is available to the consignee delivery address, time window factors that are used to determine one or more time windows in which scheduled delivery service is available to the consignee delivery address; determining by the apparatus one or more time windows in which the delivery can be scheduled, based at least in part on one or more of the time window factors selected from the group consisting of historical frequency of deliveries, traffic congestion information, traffic accidents, inclement weather, visiting dignitaries, and announced road construction; storing by the apparatus, in the carrier data storage device, the one or more time windows in which the delivery can be scheduled; providing by the apparatus to the consignor, by electronic data communication over a network, the one or more time windows in which the delivery can be scheduled; receiving by the apparatus an indication from the consignor, by electronic data communication over the network, in which the indication includes a consignee selection of one of the one or more time windows; and storing by the apparatus, in the carrier data storage device, the consignee selection of one of the one or more time windows.

In another embodiment of the present invention, a computer program embodied on a computer-readable medium for providing scheduled delivery service to consignee is provided. The computer program embodied on a computer-readable medium may include a first executable portion for receiving consignee order information from a consignee order file stored in a memory device, in which the consignee order information includes at least a consignee delivery address; a second executable portion for retrieving scheduled delivery service rules used to determine whether scheduled delivery service is available to a consignee delivery address; and a third executable portion for determining if scheduled delivery service is available to the consignee delivery address, based at least in part on one or more of the scheduled delivery service rules selected from the group consisting of frequency of failed delivery attempts rules, driver release rules, traffic congestion information rules, traffic accident rules, inclement weather rules, visiting dignitary rules, announced road construction rules, signature required rules, and number of left turns rules. Additionally, the scheduled delivery service rules may relate to historical and/or current delivery data and/or conditions. Furthermore, the computer program embodied on a computer-readable medium may further include a fourth executable portion for retrieving by the apparatus, from a carrier data storage device, upon determining that scheduled delivery service is available to the consignee delivery address, time window factors that are used to determine one or more time windows in which scheduled delivery service is available to the consignee delivery address; a fifth executable portion for determining by the apparatus one or more time windows in which the delivery can be scheduled, based at least in part on one or more of the time window factors selected from the group consisting of historical frequency of deliveries, traffic congestion information, traffic accidents, inclement weather, visiting dignitaries, and announced road construction; a sixth executable portion for storing by the apparatus, in the carrier data storage device, the one or more time windows in which the delivery can be scheduled; a seventh executable portion for providing by the apparatus to the consignor, by electronic data communication over a network, the one or more time windows in which the delivery can be scheduled; an eighth executable portion for receiving by the apparatus an indication from the consignor, by electronic data communication over the network, in which the indication includes a consignee selection of one of the one or more time windows; and a ninth executable portion for storing by the apparatus, in the carrier data storage device, the consignee selection of one of the one or more time windows.

In a further embodiment, a system for providing scheduled delivery service to consignee is provided. The system may include a consignee device configured to provide consignee order information to a consignor by electronic data communication over a network, in which the consignee order information included at least a consignee delivery address; receive from the consignor by electronic data communication over the network a notice providing one or more time windows in which a delivery may be scheduled, in which the one or more time windows based on the delivery have one or more characteristics selected from the group consisting of non-driver release area, high send again area, high traffic congestion area, high traffic accident area, high inclement weather area, shipment designated signature required, and high left turn route; and provide, by electronic data communication over the network to the consignor, a consignee selection of one of the one or more time windows.

In another embodiment, another system for providing scheduled delivery service to consignee is provided. The system may include a consignor device in electronic communication with a consignee device and a carrier device, in which the consignor device is configured to receive, by electronic data communication over the network, consignee order information from a consignee, in which the consignee order information includes at least a consignee delivery address; store consignee order information in a consignee order file in a memory device; provide consignee order information to a carrier by electronic data communication over the network; receive from the carrier, by electronic data communication over the network, a notice providing one or more time windows in which a delivery may be scheduled, in which the one or more time windows based on the delivery have one or more characteristics selected from the group consisting of non-driver release area, high send again area, high traffic congestion area, high traffic accident area, high inclement weather area, shipment designated signature required, and high left turn route; provide to the consignee, by electronic data communication over the network, the one or more time windows in which the delivery can be scheduled; receive, by electronic data communication over the network, a consignee selection of one of the one or more time windows; and provide the selection to the carrier, by electronic data communication over the network, in which the indication includes the consignee selection of one of the one or more time windows.

Furthermore, in an additional embodiment, another system for providing scheduled delivery service to consignee is provided. The system may include a consignee device configured to provide consignee order information to a carrier by electronic data communication over a network, in which the consignee order information includes at least a consignee delivery address; receive from the carrier by electronic data communication over the network a notice providing one or more time windows in which a delivery may be scheduled, in which the one or more time windows based on the delivery have one or more characteristics selected from the group consisting of non-driver release area, high send again area, high traffic congestion area, high traffic accident area, high inclement weather area, shipment designated signature required, and high left turn route; and provide, by electronic data communication over the network to the carrier, a consignee selection of one of the one or more time windows.

Even more, in a further embodiment, another system for providing scheduled delivery service to consignee is provided. The system may include a carrier device configured to receive, by electronic data communication over a network, consignee order information from a consignee order file stored in a memory device, in which the consignee order information includes at least a consignee delivery address; retrieve, from a carrier data storage device, scheduled delivery service rules used to determine whether scheduled delivery service is available to a consignee delivery address; determine if scheduled delivery service is available to the consignee delivery address, based at least in part on one or more of the scheduled delivery service rules selected from the group consisting of frequency of failed delivery attempts rules, driver release rules, traffic congestion information rules, traffic accident rules, inclement weather rules, visiting dignitary rules, announced road construction rules, signature required rules, and number of left turns rules; retrieve, from a carrier data storage device, upon determining that scheduled delivery service is available to the consignee delivery address, time window factors that are used to determine one or more time windows in which scheduled delivery service is available to the consignee delivery address; determine one or more time windows in which the delivery can be scheduled, one or more time windows in which a delivery may be scheduled, in which the one or more time windows based on the delivery have one or more characteristics selected from the group consisting of non-driver release area, high send again area, high traffic congestion area, high traffic accident area, high inclement weather area, shipment designated signature required, and high left turn route; store, in the carrier data storage device, the one or more time windows in which the delivery can be scheduled; provide to the consignee, by electronic data communication over a network, the one or more time windows in which the delivery can be scheduled; receive an indication from the consignee, by electronic data communication over the network, in which the indication includes a consignee selection of one of the one or more time windows; and store, in the carrier data storage device, the consignee selection of one of the one or more time windows.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of interactions and relationships and the flow of information according to an embodiment of the invented system.

FIG. 2 is a block diagram of a system that incorporates an embodiment of the present invention.

FIG. 3 is another block diagram of a system that incorporates an embodiment of the present invention.

FIG. 4 is another block diagram of a system that incorporates an embodiment of the present invention.

FIG. 5 is schematic block diagram of a Scheduled Delivery Service Server that incorporates an embodiment of the present invention.

FIGS. 6 and 7 show examples of computer devices that can be used to implement the present invention.

FIGS. 8-11 are flowcharts depicting steps of a method according to an embodiment of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

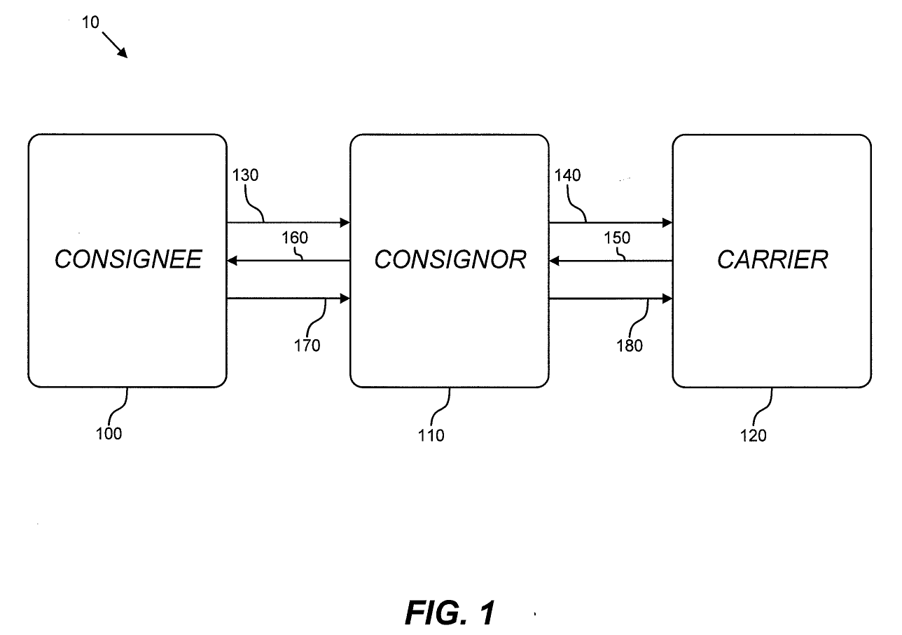

Reference is now made to FIG. 1, which diagrammatically shows relationships of various entities that may be involved in an exemplary scheduled delivery service system 10, according to an embodiment of the present invention, along with flows of information between each of the shown entities. A consignee 100 may communicate an order (for example, for the purchase of an item) to a consignor 110 via information flow 130. Or, the consignor may order shipping of an item on its own behalf and still provide destination information. Once the consignor 110 receives the order and order information associated with the order, the consignor 110 may provide the order information to a carrier 120 via flow 140. The carrier 120 may receive the order information and may determine whether scheduled delivery service is available for the consignee 100 and, if scheduled delivery service is available, may provide the consignor 110, via information flow 150, with one or more time windows in which a delivery may be scheduled. The consignor 110 may provide the consignee 100 with the one or more available time windows via flow 160, and the consignee 100 may provide a time window selection to the consignor 110 via information flow 170. The consignor 110 may then provide the carrier 120 with the consignee's time window selection via flow 180.

According to an alternative embodiment of the present invention, the consignee may communicate the order directly to the carrier via an information flow. The carrier may receive the order and order information associated with the order and may determine whether scheduled delivery service is available for the consignee. If scheduled delivery service is available, the carrier may directly provide the consignee via an information flow with one or more time windows in which a delivery may be scheduled. The consignee may then provide via an information flow a time window selection to the carrier. This alternative embodiment may pertain to a situation when the consignee is also the consignor. Such a situation may arise if an entity and/or person is shipping between two or more of its own locations. In that situation, the consignee and the consignor are the same entity and/or person, and therefore consignee may communicate directly with the carrier.

The flows depicted in FIG. 1, as well as in the alternative embodiment, may encompass communications via voice transmissions and/or data transmissions, including cellular transmission, landline telephone transmission, local area network (LAN), wide area network (WAN), email, short message service (SMS), in-person communication, or any other form of voice transmission or data transmission that the consignee 100, consignor 110, or carrier 120 may employ. Additionally, alternative and supplementary information flows between entities depicted in FIG. 1 or included in the alternative embodiment may be utilized in the scheduled delivery service system 10, according to various embodiments of the present invention. Furthermore, one or more additional entities may be included in the system 10, according to various embodiments of the present invention.

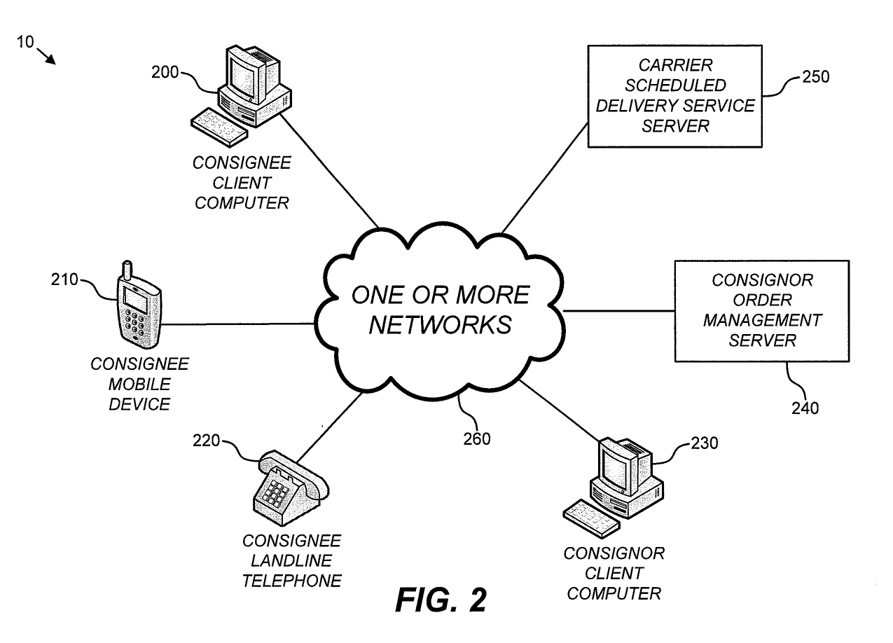

FIG. 2 is a block diagram of the scheduled delivery service system 10 in accordance with an embodiment of the present invention. As represented in this figure, the scheduled delivery service system 10 may include one or more consignee devices, such as a consignee client computer 200, a consignee mobile device 210, and/or a consignee landline telephone 220, a consignor client computer 230, a consignor order management server 240, a carrier scheduled delivery service server 250, and one or more networks 260. As can be appreciated by one of ordinary skill in the art, the one or more networks 260 may facilitate communication between the consignee client computer 200, the consignee mobile device 210, the consignee landline telephone 220, the consignor client computer 230, the consignor order management server 240, and the carrier scheduled delivery service server 250. These one or more networks 260 may include any of a variety of types of networks that can facilitate voice and/or data transmission, including but not limited to, the Internet, a private intranet, a public switch telephone network (PSTN), or any other type of network known in the art. Additionally, one or more of the components utilized in the scheduled delivery service system 10 may be combined with another component in the system, and additional or fewer components may be included in the system 10, according to various embodiments of this invention.

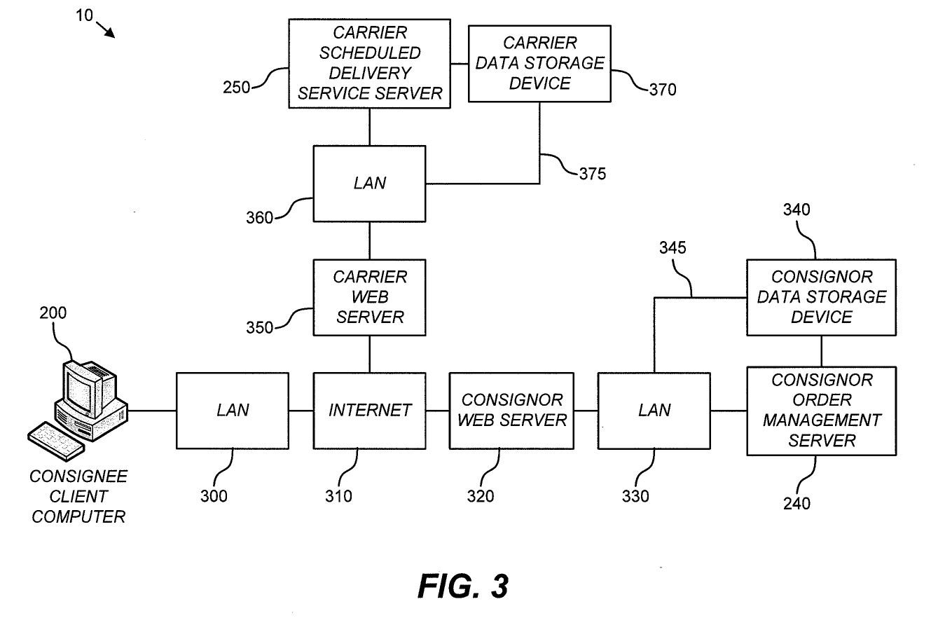

FIG. 3 is another block diagram of a scheduled delivery system 10 in accordance with an embodiment of the present invention. In FIG. 3, the communication link between the consignee 100 associated with a consignee client computer 200 and the consignor 110 associated with a consignor order management server 240 may be implemented by connecting the consignee client computer to a consignee LAN 300 which is connected, via the Internet 310 using Internet protocol (IP), and to a consignor web server 320, which is in turn connected via a consignor LAN 330 to the consignor order management server 240. A consignor data storage device 340 may be provided to serve as a storage facility for the consignor order management server 240, and the communication link between the consignor data storage device 340 and the consignor order management server 240 may be implemented via a direct connection or via a wired or wireless network, including, for example, a wired or wireless personal area network (PAN), a LAN (which may or may not be the consignor LAN 330—see line 345), a WAN, and/or the like. Additionally, the communication link between the consignor order management server 240 and the carrier 120 associated with the carrier scheduled delivery service server 250 may be implemented via the consignor LAN 330 and the consignor web server 320, via the Internet 310 using Internet protocol (IP), to a carrier web server 350, and then on to the carrier scheduled delivery service server 250 via a carrier LAN 360. Furthermore, a carrier data storage device 370 may be provided to serve as a storage facility for the carrier scheduled delivery service server 250, and the communication link between the carrier data storage device 370 and the carrier scheduled delivery service server 250 may be implemented via a direct connection or via a wired or wireless network, including, for example, a wired or wireless personal area network (PAN), a LAN (which may or may not be the carrier LAN 360—see line 375), a WAN, and/or the like.

According to alternative embodiments of the present invention in which the consignee may communicate the order directly to the carrier without a consignor as an intermediary, the communication link between the consignee associated with a consignee client computer and the carrier associated with a carrier scheduled delivery service server may be implemented by connecting the consignee client computer to a consignee LAN which is connected, via the Internet using Internet protocol (IP), and to a carrier web server, which is in turn connected via a carrier LAN to the carrier scheduled delivery service server. Furthermore, a carrier data storage device may be provided to serve as a storage facility for the carrier scheduled delivery service server, and the communication link between the carrier data storage device and the carrier scheduled delivery service server may be implemented via a direct connection or via a wired or wireless network, including, for example, a wired or wireless personal area network (PAN), a LAN (which may or may not be the carrier LAN), a WAN, and/or the like.

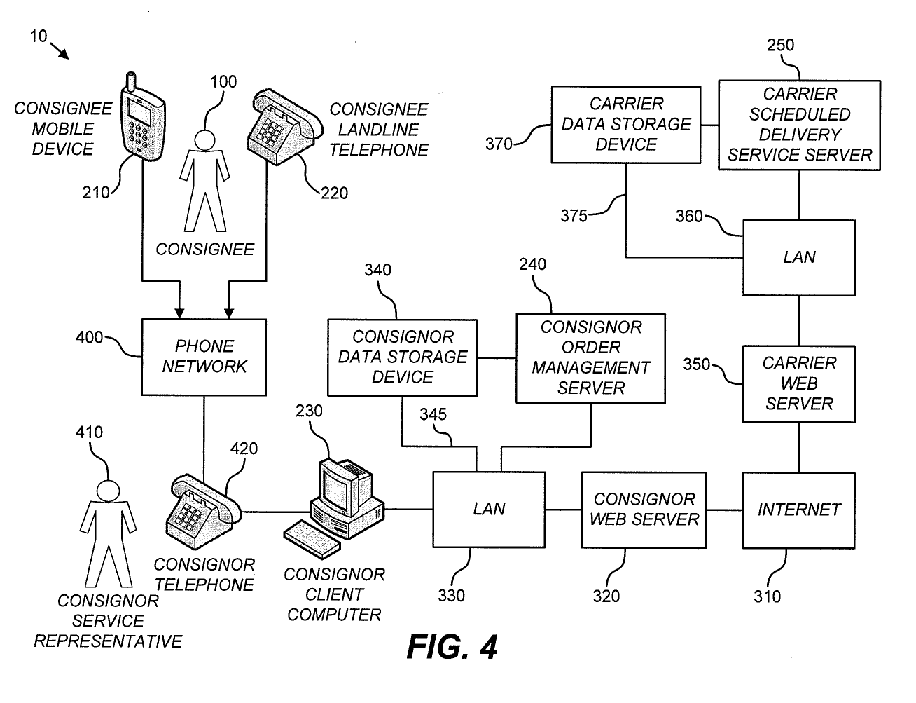

FIG. 4 represents an alternative embodiment of the scheduled delivery service system 10 depicted in FIG. 3. In FIG. 4, the communication link between the consignee 100 and the consignor 110 is via a consignor service representative 410 and may be implemented via either a consignee mobile device 210 or a consignee landline telephone 220, via a phone network 400, and via a consignor telephone 420. The communication link between the consignor service representative 410 and the consignor order management server 240 may be implemented via the consignor client computer 230, through which the consignor service representative 410 may enter the consignee order information. Furthermore, as is the same as in FIG. 3, the consignor data storage device 340 may be provided to serve as a storage facility for the consignor order management server 240, and the communication link between the consignor data storage device 340 and the consignor order management server 240 may be implemented via a direct connection or via a wired or wireless network, including, for example, a wired or wireless personal area network (PAN), a LAN (which may or may not be the consignor LAN 330—see line 345), a WAN, and/or the like. Additionally, as is the same in FIG. 3, the communication link between the consignor order management server 240 and the carrier 120 via the carrier scheduled delivery service server 250 may be implemented via the consignor LAN 330 and the consignor web server 320, via the Internet 310 using Internet protocol (IP) and via the carrier web server 350, and the communication link between the carrier web server 350 and the carrier scheduled delivery service server 250 may be implemented via the carrier LAN 360. Furthermore, as is also the same as in FIG. 3, the carrier data storage device 370 may be provided to serve as a storage facility for the carrier scheduled delivery service server 250, and the communication link between the carrier data storage device 370 and the carrier scheduled delivery service server 250 may be implemented via a direct connection or via a wired or wireless network, including, for example, a wired or wireless PAN, LAN (which may or may not be the carrier LAN 360—see line 375), WAN, and/or the like.

Furthermore, in accordance with alternative embodiments of the present invention in which the consignee may communicate the order directly to the carrier without a consignor as an intermediary, the communication link between the consignee and the carrier may be via a carrier service representative and may be implemented via either a consignee mobile device or a consignee landline telephone, via a phone network, and via a carrier telephone. The communication link between the carrier service representative and the carrier scheduled delivery service server may be implemented via a carrier client computer, through which the carrier service representative may enter the consignee order information. Furthermore, the carrier data storage device may be provided to serve as a storage facility for the carrier scheduled delivery service server, and the communication link between the carrier data storage device and the carrier scheduled delivery service server may be implemented via a direct connection or via a wired or wireless network, including, for example, a wired or wireless personal area network (PAN), a LAN (which may or may not be the carrier LAN), a WAN, and/or the like.

In accordance with alternative embodiments of the present invention, each of the communication links depicted as implemented by a LAN in FIGS. 3-4, as well as depicted as implemented by a LAN in the alternative embodiments of FIGS. 3-4 in which the consignee communicates directly with the carrier, may be implemented via any wired or wireless network, including, for example, a wired or wireless PAN, LAN (which may or may not be the consignee LAN 300, consignor LAN 330, or carrier LAN 360), WAN, and/or the like. Additionally, in both embodiments, while shown as separate devices communicating with each other either directly or via a wired or wireless network, as one of ordinary skill in the art will recognize in light of this disclosure, some or all of the data stored in the consignor data storage device 340 may be stored in the consignor order management server 240. Similarly, although the consignor order management server 240 and the consignor data storage device 340 are shown as separate components in these embodiments, as one of ordinary skill in the art will recognize in light of this disclosure, the consignor data storage device 340 and the consignor order management server 240 may reside on the same server, or network entity. Furthermore, in both embodiments, while shown as separate devices communicating with each other either directly or via a wired or wireless network, as one of ordinary skill in the art will recognize in light of this disclosure, some or all of the data stored in the carrier data storage device 370 may be stored in the carrier scheduled delivery service server 250. Similarly, although the carrier scheduled delivery service server 250 and the carrier data storage device 370 are shown as separate components in these embodiments, as one of ordinary skill in the art will recognize in light of this disclosure, the carrier data storage device 370 and the carrier scheduled delivery service server 250 may reside on the same server, or network entity. Even more, although the embodiments shown in FIGS. 3-4 include the consignor web server 320 and a carrier web server 350, one or both of the consignor web server 320 and the carrier web server 350 may be another type of network entity.

Furthermore, although the consignee client computer 200, the consignee telephone 210, the consignee mobile device 220, the consignor client computer 230, the consignor order management server 240, the carrier scheduled delivery service server 250, the consignor web server 320, the consignor data storage device 340, the carrier web server 350, and the carrier data storage device 370 are each pictured in FIGS. 3-4 as individual components, and are described as individual components in the alternative embodiments of FIGS. 3-4 in which the consignee communicates directly with the carrier, as one of ordinary skill in the art will recognize in light of this disclosure, one or more of the components may be combined with another component in the system, and additional or fewer components may be included in the system 10, according to various embodiments of this invention. Even more, as one of ordinary skill in the art will recognize in light of this disclosure, while reference is made throughout this disclosure to a “server,” embodiments of the present invention are not limited to a client-server architecture. In contrast, any central or distributed computer or network system may likewise be used to perform the functionality described herein without departing from the spirit and scope of embodiments of the present invention.

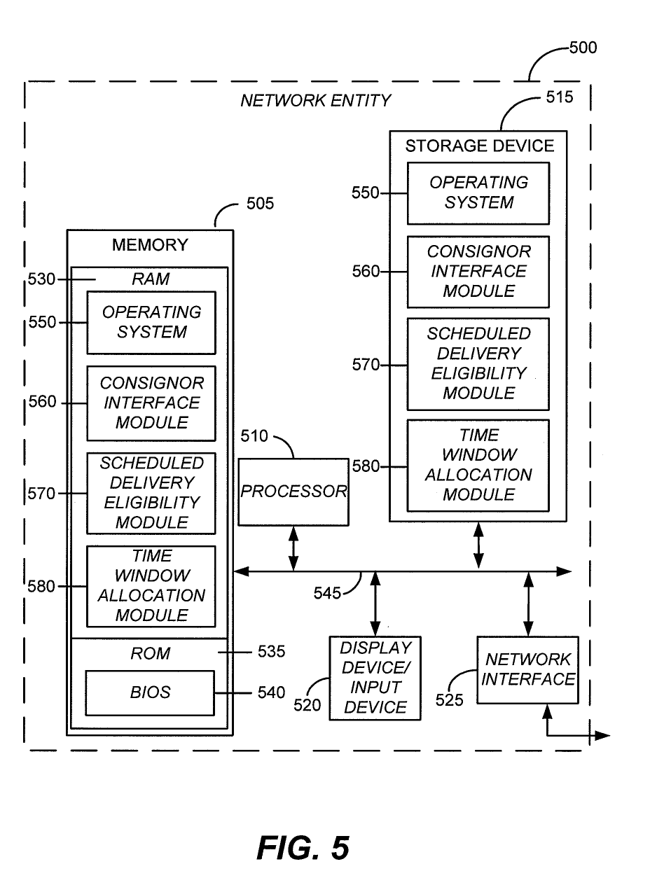

FIG. 5 shows a schematic diagram of the scheduled delivery service server 500, or similar network entity, configured to determine whether to offer scheduled delivery service and which time windows to offer for scheduled delivery service, according to an embodiment of the invention. As may be understood from FIG. 5, in this embodiment, the scheduled delivery service server 500 may include a processor 510 that communicates with other elements within the scheduled delivery service server 500 via a system interface or bus 545. The processor 510 could be, for example, a central processing unit, microprocessor, microcontroller, programmable gate array, or some other device that processes data. Also included in the scheduled delivery service server 500 may be a display device/input device 520 for receiving and displaying data. This display device/input device 520 may be, for example, a keyboard, mouse or pointing device that is used in combination with a display device such as a monitor, cathode ray tube (CRT), liquid crystal display (LCD), or other such device. The scheduled delivery service server 500 may further include memory 505, which may include both read only memory (ROM) 535 and random access memory (RAM) 530. The server's ROM 535 may be used to store a basic input/output system 540 (BIOS) containing the basic routines that help to transfer information between elements within the scheduled delivery service server 500.

In addition, the scheduled delivery service server 500 may include at least one storage device 515, such as a hard disk drive, a floppy disk drive, a CD-ROM drive, or optical disk drive, for storing information on various computer-readable media, such as a hard disk, a removable magnetic disk, or a CD-ROM disk. As will be appreciated by one of ordinary skill in the art, each of these storage devices 515 may be connected to the system bus 545 by an appropriate interface. The storage devices 515 and their associated computer-readable media may provide nonvolatile storage for a personal computer. The computer-readable media described above could be replaced by any other type of computer-readable media known in the art. Such media include, for example, magnetic cassettes, flash memory cards, digital video disks, and Bernoulli cartridges.

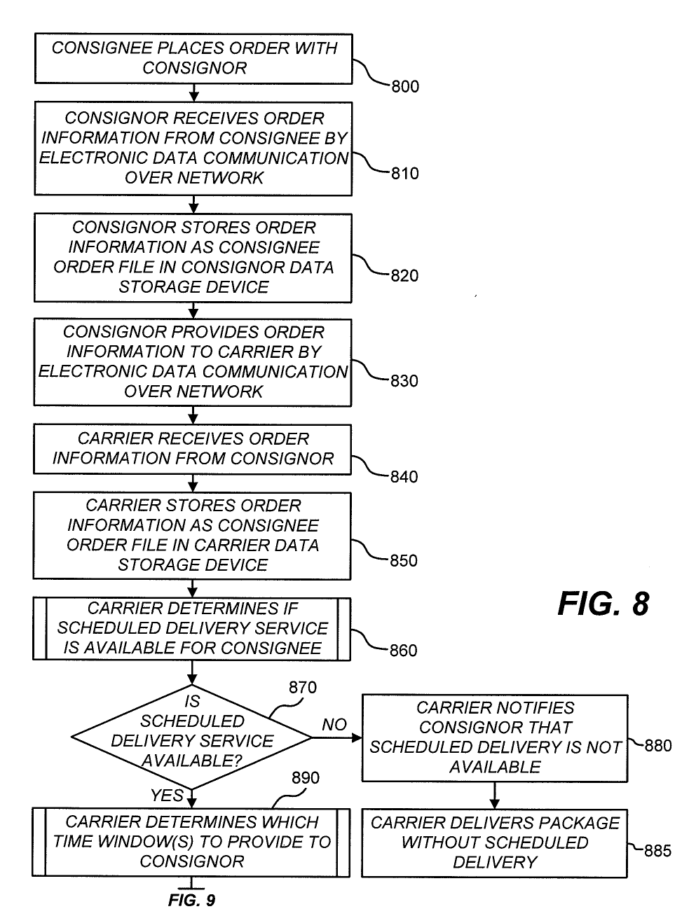

A number of program modules comprising, for example, one or more computer-readable program code portions executable by the processor 510, may be stored by the various storage devices and within RAM 530. Such program modules may include an operating system 550, a consignor interface module 560, scheduled delivery service eligibility module 570, and a time window allocation module 580. The consignor interface module 560, scheduled delivery service eligibility module 570, and time window allocation module 580 may control certain aspects of the operation of the scheduled delivery service server 500, as described in more detail herein, with the assistance of the processor 510 and the operating system 550. For example, as discussed in more detail below with regard to FIGS. 8-11, the consignor interface module 560 may receive information from the consignor, such as consignee order information and a consignee time window selection, and may provide information to the consignor, such as time windows for which scheduled delivery service is available. Additionally, the scheduled delivery eligibility module 570 may determine whether scheduled delivery service is available for the consignee. Furthermore, the time window allocation module 580 may determine which time window(s) to offer for scheduled delivery service. While the foregoing describes the software of embodiments of the invention in terms of modules by way of example, as one of ordinary skill in the art will recognize in light of this disclosure, the software associated with embodiments of the invention need not be modularized and, instead, may be intermingled or written in other non-modularized formats.

While not shown, according to an embodiment, the storage device 515 and/or memory 505 may further provide the functions of the data storage device 340, as shown in FIGS. 3-4, which, as discussed below, may store historical and/or current delivery data and delivery conditions that may be accessed by the scheduled delivery service module 560.

Also located within the scheduled delivery service server 500 may be a network interface 525 for interfacing and communicating with other elements of a computer network, such as elements shown in FIG. 2. It will be appreciated by one of ordinary skill in the art that one or more of the scheduled delivery service server 500 components may be located geographically remotely from other scheduled delivery service server 500 components. Furthermore, one or more of the components may be combined, and additional or fewer components performing functions described herein may be included in the scheduled delivery service server 500.

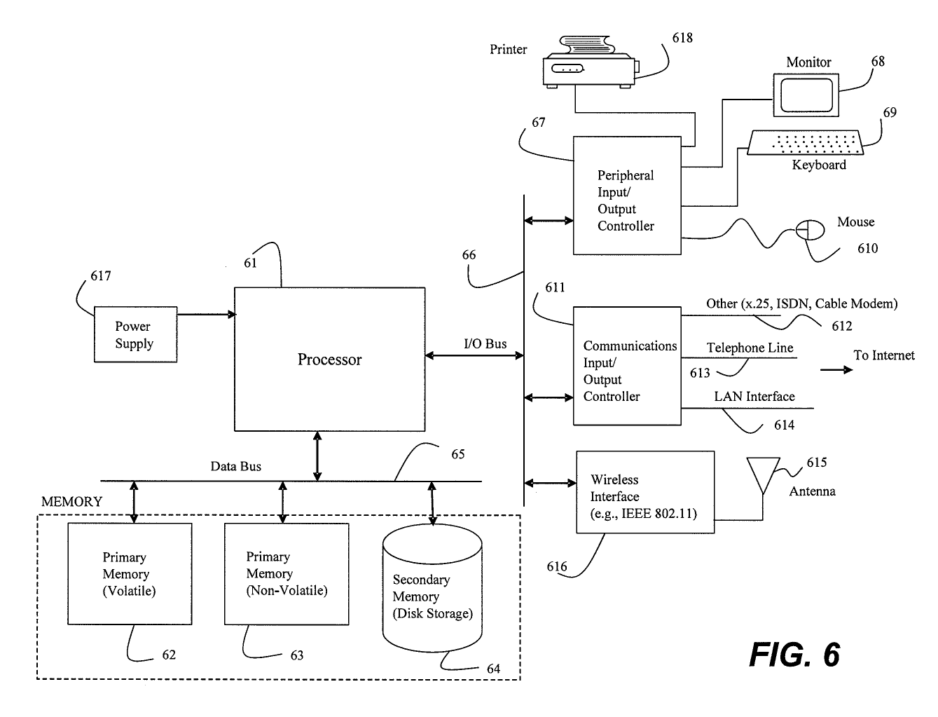

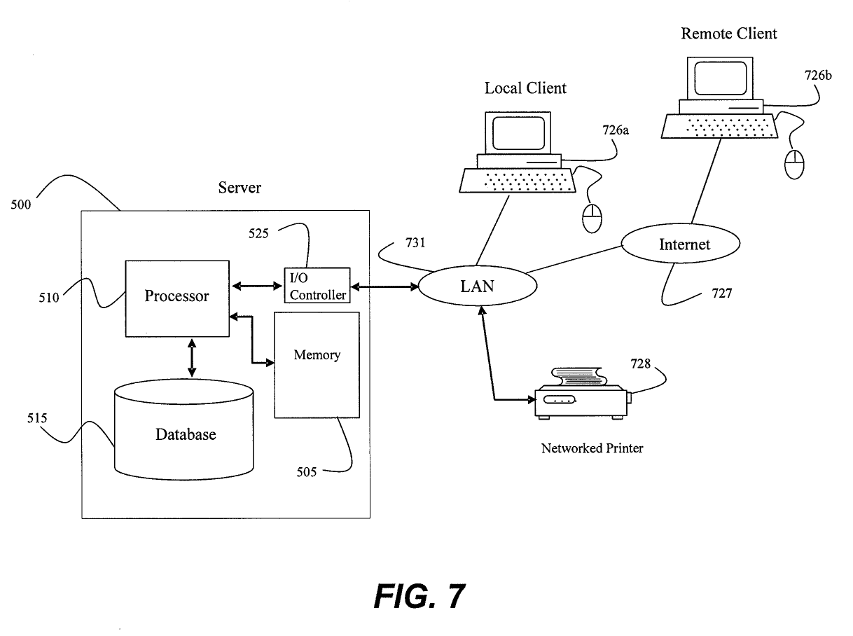

Some method steps of the present invention may be completed by updating computer memories or transferring information from one computer memory to another. Other examples of computer components that may be used to implement the present invention (for example, the modules of FIG. 5) are described in connection with FIGS. 6 and 7. Turning to FIG. 6, an embodiment of a computer is illustrated that can be used to practice aspects of the present invention, such as the various computer systems described herein. The systems and methods of the present invention can be implemented using computer hardware and computer readable memory containing information and instructions to carry out the disclosed method. In FIG. 6, a processor 61, such as a microprocessor, is used to execute software instructions for carrying out the defined steps. The processor receives power from a power supply 617 that also provides power to the other components as necessary. The processor 61 communicates using a data bus 65 that is typically 16 or 32 bits wide (e.g., in parallel). The data bus 65 is used to convey data and program instructions, typically, between the processor and memory. In the present embodiment, memory can be considered volatile primary memory 62, such as RAM or other forms which retain the contents only during operation, or it may be non-volatile primary memory 63, such as ROM, EPROM, EEPROM, FLASH, or other types of memory that retain the memory contents at all times. The memory could also be secondary memory 64, such as disk storage, that stores large amount of data. In some embodiments, the disk storage may communicate with the processor using an I/O bus 66 or a dedicated bus (not shown). The secondary memory may be a floppy disk, hard disk, compact disk, DVD, or any other type of mass storage type known to those skilled in the computer arts. One of ordinary skill will recognize that as data is transferred between two or more computing devices (in accordance with the below-described processing steps), the data is read from and written to one or more of these memory areas and the memory area is physically changed as a result of the process.

The processor 61 also communicates with various peripherals or external devices using the I/O bus 66. In the present embodiment, a peripheral I/O controller 67 is used to provide standard interfaces, such as RS-232, RS422, DIN, USB, or other interfaces as appropriate to interface various input/output devices. Typical input/output devices include local printers 618, a monitor 68, a keyboard 69, and a mouse 610 or other typical pointing devices (e.g., rollerball, trackpad, joystick, etc.).

The processor 61 typically also communicates with external communication networks using a communications I/O controller 611, and may use a variety of interfaces such as data communication oriented protocols 612 such as X.25, ISDN, DSL, cable modems, etc. The communications I/O controller 611 may also incorporate a modem (not shown) for interfacing and communicating with a standard telephone line 613. Additionally, the communications I/O controller may incorporate an Ethernet interface 614 for communicating over a LAN. Any of these interfaces may be used to access the Internet, intranets, LANs, or other data communication facilities.

Also, the processor 61 may communicate with a wireless interface 616 that is operatively connected to an antenna 615 for communicating wirelessly with other devices, using for example, one of the IEEE 802.11 protocols, 802.15.4 protocol, or a standard 3G wireless telecommunications protocol, such as CDMA2000 1x EV-DO, GPRS, W-CDMA, or other protocol.

A further alternative embodiment of a processing system that may be used is shown in FIG. 7. In this embodiment, a distributed communication and processing architecture is shown involving, for example, the scheduled delivery service server 500 communicating with either a local client computer 726a or a remote client computer 726b. The server 500 typically comprises a processor 510 that communicates with a database 515, which can be viewed as a form of secondary memory, as well as primary memory 505. The processor also communicates with external devices using an I/O controller 525 that typically interfaces with a local area network (LAN) 731. The LAN may provide local connectivity to a networked printer 728 and the local client computer 726a. These may be located in the same facility as the server, though not necessarily in the same room. Communication with remote devices typically is accomplished by routing data from the LAN 731 over a communications facility to the Internet 727. A remote client computer 726b may execute a web browser, so that the remote client 726b may interact with the server 500 as required by transmitted data through the Internet 727, over the LAN 731, and to the server 500. The one or more networks 270 in FIG. 2 may be the Internet 727. References made herein to a network are meant to include one or more networks configured to carry out the function or feature being described.

Those skilled in the art of data networking will realize that many other alternatives and architectures are possible and can be used to practice the principles of the present invention. The embodiments illustrated in FIGS. 6 and 7 can be modified in different ways and be within the scope of the present invention as claimed. It should be understood that many individual steps of a process according to the present invention may or may not be carried out utilizing the computer systems described, and that the degree of computer implementation may vary.

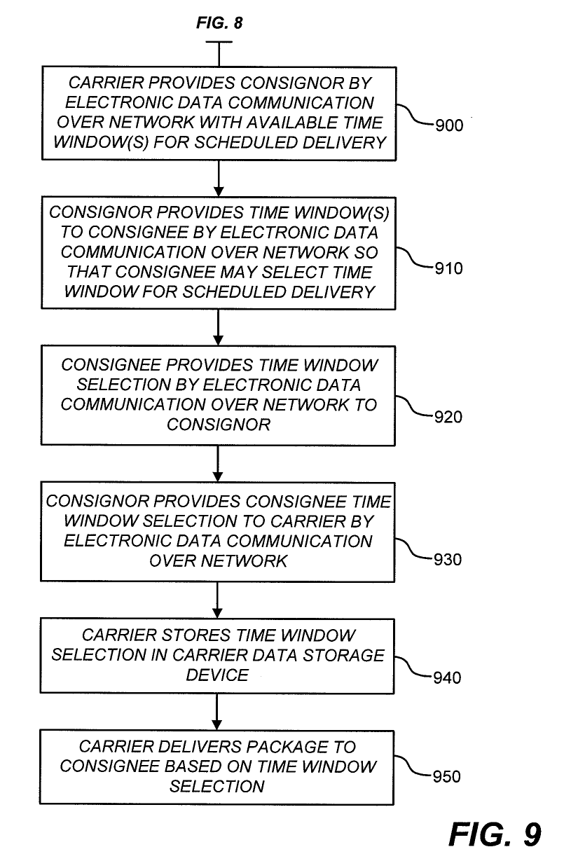

Reference is now made to FIGS. 8-9, which illustrate the process by which the consignee may place an order, the carrier may determine whether to offer scheduled delivery service to the consignee, and the carrier may determine which time window(s) to offer for scheduled delivery service, according to an embodiment of the invention. As shown in Block 800, the process may be initiated when the consignee places an order with the consignor. The order may include at least a delivery address to where the consignee would like the consignor to deliver the package. The consignee, initiated through a consignee computer, may place the order on the Internet through the consignor's web site or through a web site selling the consignor's products, among other methods, including via email, over the telephone (landline, mobile, satellite, or other type of telephone), via SMS, via catalog order, via postal service mail, through an in-store transaction, and via any other applicable method, according to various embodiments of the present invention. Once the consignee places the order, the consignor, in Block 810, may receive the order information from the consignee by electronic data communication over a network and may, in Block 820, store the order information as a consignee order file in a consignor memory device, which may comprise, according to various embodiments, the consignor data storage device, the consignor order management system, or the consignor client computer. In additional embodiments, the consignee may provide profile information to the consignor either in association with the order information or separate from the order information, and the consignee profile information may be stored by the consignor in the consignor memory device, which may comprise, according to various embodiments, the consignor data storage device, the consignor order management system, or the consignor client computer. After receiving the order information from the consignee, the consignor may provide the order information to the carrier (Block 830) by electronic data communication over a network, and the carrier may receive the order information from the consignor (Block 840). Once the carrier receives the order information, the carrier may store the order information as a consignee order file in a carrier memory device, such as the carrier data storage device, the scheduled delivery service server, or other network entity (Block 850). In addition to or in association with the order information, the consignor may provide consignee profile information to the carrier. The consignee profile information may be stored by the carrier in the carrier memory device, such as the carrier data storage device, the scheduled delivery service server, or other network entity.

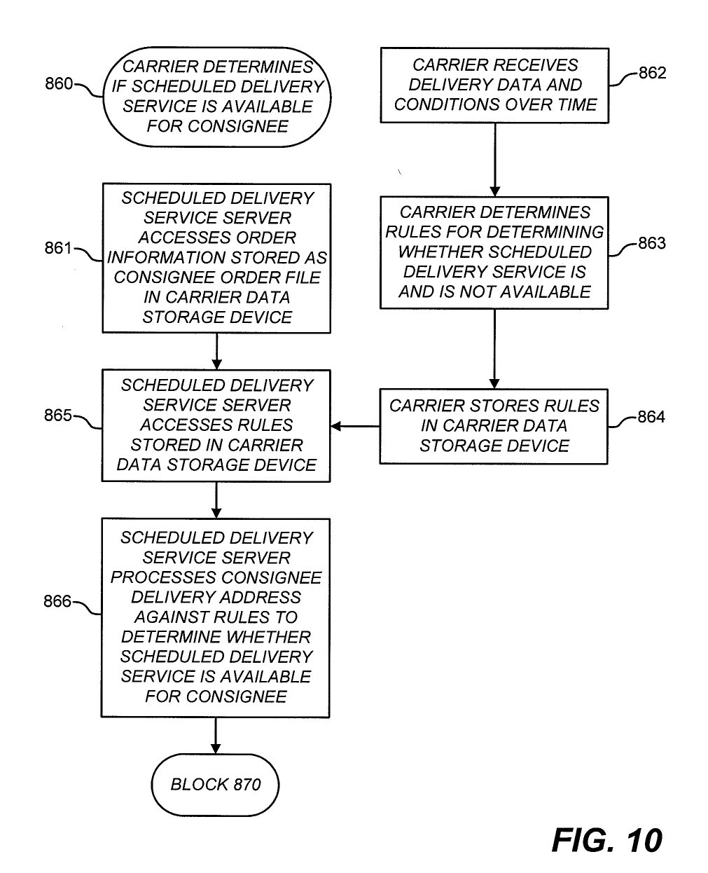

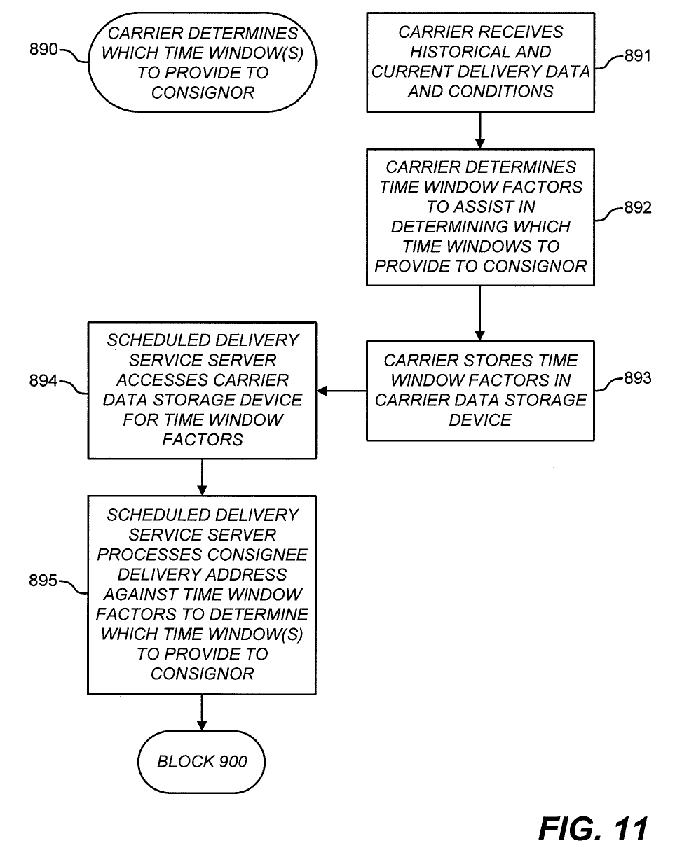

Next, in Block 860, the carrier may determine whether scheduled delivery service is available for the consignee. The determination may be based at least in part on various factors, including, for example, data included in the order information, such as the consignee delivery address, historical and/or current delivery data and/or conditions, or shipment-specific characteristics, among other factors. This process in Block 860 will be described in greater detail below in FIG. 10. Once the carrier makes a determination whether scheduled delivery service is available for the consignee, Block 870 directs the carrier to the next step in the process. If, in Block 870, scheduled delivery service is not available, the carrier may notify the consignor by electronic data communication over a network that scheduled delivery service is not available (Block 880), and the carrier may deliver the package to the consignee without scheduled delivery service (Block 885). If, however, in Block 870, scheduled delivery service is available, the carrier may determine, in Block 890, which time window(s) to provide to the consignor for which scheduled delivery service is available. The determination may be based at least in part on various factors, including, for example, data included in the order information, such as the consignee delivery address, historical and/or current delivery data and/or conditions, or shipment-specific characteristics, among other factors. The process of time window determination will be further explained below in FIG. 11.

Continuing to FIG. 9, upon determining which time window(s) to provide to the consignor, the carrier may provide the time window(s) to the consignor, in Block 900, by electronic data communication over the network, and the consignor, in Block 910, may provide the time window(s) to the consignee, by electronic data communication over the network, so that the consignee may select a time window for scheduled delivery. In Block 920, the consignee may provide a time window selection to the consignor by electronic data communication over the network, and in Block 930, the consignor may, by electronic data communication over the network, provide the consignee time window selection to the carrier, which, in Block 940, the carrier may store in the carrier memory device, which may include, without limitation, the carrier data storage device, the scheduled delivery service server, or other similar network entity. Once the carrier receives the consignee time window selection, the carrier, in Block 950, may deliver the package to the consignee via scheduled delivery service in accordance with the consignee time window selection.

Referring now to FIG. 10, FIG. 10 provides further detail of the process introduced in Block 860 in FIG. 8, in which the carrier may determine if scheduled delivery service is available for the consignee, a determination that may be based at least in part upon various factors, including, for example, data included in the order information, such as the consignee delivery address, historical and/or current delivery data and/or conditions, or shipment-specific characteristics, among other factors. The process may begin when the scheduled delivery service server accesses order information (Block 861) stored as a consignee order file in the carrier memory device, which may include, without limitation, the carrier data storage device, the scheduled delivery service server, or other similar network entity. The order information may include, among other pieces of information, the consignee delivery address, the name of the consignee, or the specific type of transaction. Additionally, the order information may be provided by the consignee when placing an order with the consignor, or may be retrieved from a consignee profile, for example, provided earlier by the consignee to the consignor and stored in the consignor memory device, such as the consignor data storage device, the consignor order management server, or other network entity. Alternatively, the order information may be retrieved by the carrier from similar profile data or order information stored previously in the carrier memory device, such as the carrier data storage device, the scheduled delivery service server, or other network entity.

Once the scheduled delivery service server has accessed the consignee order information, the scheduled delivery service server may be ready to process the consignee order information against historical and/or current delivery data and/or conditions or shipment-specific characteristics to determine whether scheduled delivery service is available for the consignee. As shown in Block 862, the carrier may receive delivery data and conditions over time, thus accumulating historical and/or current delivery data and/or conditions. Using the historical and/or current delivery data and/or conditions, the carrier, in Block 863, may determine rules for determining whether scheduled delivery service is and is not available for a consignee delivery address. In addition to delivery data and conditions, the carrier may receive and utilize commonly available online information in order to determine the rules for determining whether scheduled delivery service is and is not available for a consignee delivery address. Furthermore, the carrier may determine scheduled delivery service rules related to shipment-specific characteristics, including, for example, rules related to shipments designated “signature required” and the number of left turns that must be made by a delivery vehicle on a delivery route to a consignee delivery address.

One type of rule, according to various embodiments of the present invention, may be related to the frequency of failed delivery attempts. Failed first delivery attempts may increase the carrier's costs because the carrier may have to make additional delivery attempts in order to deliver a package. The historical delivery data may include information regarding the number of delivery attempts required per delivery for deliveries to addresses located within geographic areas, among other information. Using this information, the carrier may calculate or identify a threshold frequency of delivery attempts per delivery, above which the carrier may determine that it may offer scheduled delivery service for the consignee. Geographic areas in which the frequency of delivery attempts per delivery is greater than the threshold frequency may be identified and referred to as “high send-again areas”. Therefore, the carrier may identify frequency of failed delivery attempt rules that indicate that scheduled delivery service will be offered for deliveries to addresses within the high send-again areas, whereas addresses that are not located within high send-again areas may not qualify under this test for scheduled delivery service.

Additionally, the historical delivery data may include information regarding the number of delivery attempts required per delivery for deliveries to specific addresses. Using this information, the carrier may calculate or identify a threshold frequency of delivery attempts per delivery, above which the carrier may determine that it may offer scheduled delivery service for the consignee. Accordingly, in order to minimize the number of failed first deliveries, if the historical delivery data indicates that the frequency of delivery attempts per delivery to a specific address is greater than the threshold frequency, scheduled delivery service may be offered for deliveries to the specific address, whereas scheduled delivery service may not be offered for deliveries to other addresses. Therefore, the carrier may identify frequency of failed delivery attempt rules that indicate that scheduled delivery service will be offered for deliveries to specific addresses for which the historical delivery data indicates that the frequency of delivery attempts per delivery to each of the specific addresses is greater then the threshold frequency, whereas specific addresses for which the historical delivery data indicates that the frequency of delivery attempts per delivery to each of the specific addresses is not greater then the threshold frequency may not qualify under this test for scheduled delivery service.

Moreover, the historical delivery data may include information regarding the number of delivery attempts required per delivery for deliveries to specific consignees. Using this information, the carrier may calculate or identify a threshold frequency of delivery attempts per delivery, above which the carrier may determine that it may offer scheduled delivery service for the consignee. Accordingly, in order to minimize the number of failed first deliveries, if the historical delivery data indicates that the frequency of delivery attempts per delivery to a specific consignee is greater then the threshold frequency, scheduled delivery service may be offered for deliveries to the specific consignee, whereas scheduled delivery service may not be offered for deliveries to other consignees. Therefore, the carrier may identify frequency of failed delivery attempt rules that indicate that scheduled delivery service will be offered for deliveries to specific consignees for which the historical delivery data indicates that the frequency of delivery attempts per delivery to each specific consignee is greater then the threshold frequency, whereas specific consignees for which the historical delivery data indicates that the frequency of delivery attempts per delivery to each specific consignee is not greater then the threshold frequency may not qualify under this test for scheduled delivery service.

Furthermore, the historical delivery data may include information regarding the number of delivery attempts required per delivery for deliveries related to specific types of transactions. Using this information, the carrier may calculate or identify a threshold frequency of delivery attempts per delivery, above which the carrier may determine that it may offer scheduled delivery service for the consignee. Accordingly, in order to minimize the number of failed first deliveries, if the historical delivery data indicates that the frequency of delivery attempts per delivery related to a specific type of transaction is greater then the threshold frequency, scheduled delivery service may be offered for deliveries related to the specific types of transactions, whereas scheduled delivery service may not be offered for deliveries related to other types of transactions. Therefore, the carrier may identify frequency of failed delivery attempt rules that indicate that scheduled delivery service will be offered for deliveries related to specific types of transactions for which the historical delivery data indicates that the frequency of delivery attempts per delivery related to each specific type of transaction is greater then the threshold frequency, whereas specific types of transactions for which the historical delivery data indicates that the frequency of delivery attempts per delivery for each specific type of transaction is not greater then the threshold frequency may not qualify under this test for scheduled delivery service. Examples of transactions for which a carrier may choose to allow scheduled delivery service include: contents insured above a certain amount; contents include alcohol or a controlled substance, medical products, hazardous materials, perishables; or COD (collect on delivery) packages, among other specific types of transactions.

Another type of rule may be related to a carrier requirement applicable to some deliveries that indicates that the carrier will only leave a package at the consignee delivery address if the carrier first obtains a signature. In certain geographic areas, which may be referred to as “non-driver release areas,” the carrier may not leave a package unclaimed and/or unattended at the consignee delivery address. Instead, the carrier must first obtain a signature because carrier experience may indicate that the package may be stolen or damaged after the package is relinquished by the carrier. The historical delivery data may include information regarding the theft of or damage to packages left by the carrier at addresses within specific geographic areas without first obtaining a signature. Using this information, the carrier may identify non-driver release areas in which the carrier may determine that it may not leave a package without first obtaining a signature, whereas in areas other than non-driver release areas, the carrier may not require a signature before leaving a package. Accordingly, for non-driver release areas, the carrier may minimize the number of delivery attempts if the carrier has knowledge that a person will be at the consignee delivery address at the time of delivery in order to sign for the package. Thus, scheduled delivery service may offer advantages for deliveries to non-driver release areas because scheduled delivery service may ensure that a consignee may be aware of the time of delivery, and therefore, a person will be more likely to be at the consignee delivery address to sign for the package upon delivery. Therefore, the carrier may identify driver release rules that indicate that scheduled delivery service will be offered for deliveries to addresses within the non-driver release areas, whereas addresses that are not located within non-driver release areas may not qualify under this test for scheduled delivery service.

Additionally, the historical delivery data may include information regarding the theft of or damage to packages left by the carrier at specific addresses without first obtaining a signature. Using this information, the carrier may identify specific addresses for which the carrier may determine that it may not leave a package without first obtaining a signature, whereas for other addresses, the carrier may not require a signature before leaving a package. Accordingly, in order to minimize the number of delivery attempts per delivery to a specific address, if the historical delivery data indicates that the carrier may not leave a package at the specific address without first obtaining a signature, scheduled delivery service may be offered for deliveries to the specific address, whereas scheduled may not be offered for a delivery to an address in which a signature is not required before the carrier will relinquish the package. Therefore, the carrier may identify driver release rules that indicate that scheduled delivery service will be offered for deliveries to specific addresses for which the historical delivery data indicates that the carrier may not leave a package at the specific address without first obtaining a signature, whereas specific addresses for which the historical delivery data does not indicate that the carrier should only leave a package at the specific address without first obtaining a signature may not qualify under this test for scheduled delivery service.

Furthermore, the historical delivery data may include information regarding the theft of or damage to packages left by the carrier for specific consignees without first obtaining a signature. Using this information, the carrier may identify specific consignees for which the carrier may determine that it may not leave a package without first obtaining a signature, whereas for other specific consignees, the carrier may not require a signature before leaving a package. Accordingly, in order to minimize the number of delivery attempts per delivery to a specific consignee, if the historical delivery data indicates that the carrier may not leave a package for a specific consignee without first obtaining a signature, scheduled delivery service may be offered for deliveries to the specific consignee, whereas scheduled delivery service may not be offered for a delivery to a specific consignee in which a signature is not required before the carrier will relinquish the package. Therefore, the carrier may identify driver release rules that indicate that scheduled delivery service will be offered for deliveries to specific consignees for which the historical delivery data indicates that the carrier may not leave a package for the specific consignee without first obtaining a signature, whereas specific consignees for which the historical delivery data does not indicate that the carrier may not leave a package for the specific consignee without first obtaining a signature may not qualify under this test for scheduled delivery service.

Even more, the historical delivery data may include information regarding the theft of or damage to packages left by the carrier without first obtaining a signature for deliveries related to specific types of transactions. Using this information, the carrier may identify specific types of transactions for which the carrier may determine that it may not leave a package without first obtaining a signature, whereas for other types of transactions, the carrier may not require a signature before leaving a package. Accordingly, in order to minimize the number of delivery attempts per delivery for deliveries related to specific types of transactions, if the historical delivery data indicates that the carrier may not relinquish a package without first obtaining a signature for a deliveries related to the specific types of transactions, scheduled delivery service may be offered for deliveries related to the specific types of transactions, whereas scheduled delivery service may not be offered for deliveries related to specific types of transactions for which a signature is not required before the carrier will relinquish the package. Thus, the carrier may identify specific types of transactions for which scheduled delivery service may be offered for deliveries related to the specific types of transactions for which a carrier must first obtain a signature before the carrier may relinquish the package. Therefore, the carrier may identify driver release rules that indicate that scheduled delivery service will be offered for deliveries related to specific types of transactions for which the historical delivery data indicates that the carrier may not relinquish a package without first obtaining a signature for deliveries related to the specific types of transactions, whereas specific types of transactions for which the historical delivery data does not indicate that the carrier may not relinquish a package without first obtaining a signature for deliveries related to the specific types of transactions may not qualify under this test for scheduled delivery service.

Furthermore, other types of rules may concern historical delivery data and/or conditions, such as traffic congestion information, traffic accidents, inclement weather, and other factors that may impact a package delivery to the consignee delivery address, according to embodiments of the present invention. The historical delivery data and/or conditions received over time by the carrier may include statistics regarding the presence of traffic congestion, the frequency of traffic accidents, and the occurrence of inclement weather, among other conditions, at specific addresses and in areas surrounding or leading to specific addresses. In regard to traffic congestion information, the carrier may calculate or identify a threshold frequency of traffic congestion, above which the carrier may determine that it will offer scheduled delivery service for the consignee. High traffic congestion suggests that repeated delivery attempts will significantly affect the carrier's delivery network; therefore, it is beneficial to a carrier to make a successful delivery to the consignee delivery address on the first attempt. Accordingly, traffic congestion information rules may indicate that scheduled delivery service will be offered in areas in which the frequency of traffic congestion is above the threshold frequency. In regard to traffic accidents, the carrier may likewise calculate or identify a threshold frequency of traffic accidents, above which the carrier may determine that it will offer scheduled delivery service for the consignee. For areas in which there are a high number of traffic accidents, repeated delivery attempts will negatively impact the carrier's delivery network. Accordingly, it is beneficial to a carrier to make a successful delivery to the consignee delivery address on the first attempt. Therefore, traffic accident rules may indicate that scheduled delivery service will be offered in areas in which the frequency of traffic accidents is above the threshold frequency. Additionally, in regard to inclement weather, the carrier may calculate or identify a threshold frequency of occurrences of inclement weather, above which the carrier may determine that it will offer scheduled delivery service for the consignee. For areas in which the frequency of occurrences of inclement weather is above the threshold frequency, repeated delivery attempts will negatively impact the carrier's delivery network. Accordingly, it is beneficial to a carrier to make a successful delivery to the consignee delivery address on the first attempt. Thus, inclement weather rules may indicate that scheduled delivery service will be offered in areas in which the frequency of occurrences of inclement weather is above the threshold frequency.

Moreover, other types of rules may concern current delivery conditions, such as traffic congestion, traffic accidents, inclement weather, visiting dignitaries, announced road construction, and other factors that may impact a package delivery to the consignee delivery address, according to embodiments of the present invention. The current delivery conditions received by the carrier may include information regarding the presence of traffic congestion, the presence of traffic accidents, the occurrence of inclement weather, scheduled visiting dignitaries, and announced road construction, among other conditions, at specific addresses and in areas surrounding or leading to specific addresses. In regard to traffic congestion, the carrier may offer scheduled delivery service for the consignee if there is current traffic congestion in an area surrounding or leading to the consignee delivery address. Current traffic congestion suggests that planned delivery attempts in the vicinity likely will take more time than normal, indicating a high cost of failure if any of the attempts fail. Thus, avoiding the need for repeated delivery attempts to the consignees in question has a high priority. Accordingly, traffic congestion information rules may indicate that scheduled delivery service will be offered in areas in which there is current traffic congestion.

Similarly, in regard to current traffic accidents, the carrier may offer scheduled delivery service for the consignee if a traffic accident is impacting a route leading to the consignee delivery address. For areas in which there is a current traffic accident, any need for repeated delivery attempts will negatively impact the carrier's delivery network in the same manner as described above in connection with congestion. Therefore, traffic accident rules may indicate that scheduled delivery service will be offered in areas in which there is a current traffic accident. Additionally, in regard to inclement weather, the carrier may offer scheduled delivery service for the consignee if the current weather conditions will make scheduled delivery more difficult. For areas in which inclement weather is currently present, repeated delivery attempts will similarly negatively impact the carrier's delivery network. Thus, inclement weather rules may indicate that scheduled delivery service will be offered in areas in which inclement weather is currently present. Furthermore, in regard to visiting dignitaries, the carrier may offer scheduled delivery service for the consignee if a dignitary is scheduled to be visiting an area surrounding or leading to the consignee delivery address. For areas in which a dignitary is scheduled to visit, repeated delivery attempts will similarly negatively impact the carrier's delivery network. Thus, visiting dignitary rules may indicate that scheduled delivery service will be offered in areas in which a dignitary is scheduled to visit. Moreover, in regard to announced road construction, the carrier may offer scheduled delivery service for the consignee if there is announced road construction in the area surrounding or leading to the consignee delivery address. For areas in which there is announced road construction, repeated delivery attempts will similarly negatively impact the carrier's delivery network. Thus, announced road construction rules may indicate that scheduled delivery service will be offered in areas in which there is announced road construction.

Additionally, another rule may be related to a shipment-specific characteristic in which a party related to a delivery or shipment of a package requests that the carrier only leaves the package at the consignee delivery address if the carrier first obtains a signature. This request may be referred to as “signature required”, or by another analogous term, and may be requested by the consignee, consignor, or other authorized party, at the time of order placement, during order delivery and shipment, or any other time when the consignee, consignor, or other authorized party, may communicate this request to the carrier prior to delivery of the package at the consignee delivery address. Accordingly, in order to minimize the number of delivery attempts per delivery for a shipment designated as “signature required,” scheduled delivery service may be offered for a shipment designated as “signature required,” whereas scheduled delivery service may not be offered under this rule for a delivery not designated as “signature required.” Therefore, signature required rules may indicate that the carrier will offer scheduled delivery service for deliveries designated as “signature required”, whereas deliveries not designated as “signature required” may not qualify under this test for scheduled delivery service.

Another rule may be related to the number of left turns that must be made by a delivery vehicle on a delivery route to a consignee delivery address. Delivery routes that require a high number of left turns have longer delivery times, and therefore, repeated delivery attempts will greatly impact a carrier's delivery network. Accordingly, in order to minimize the impact to a carrier's delivery network that may be inflicted by repeated delivery attempts to consignee delivery addresses via routes with a high number of left turns, the carrier may calculate or identify a threshold number of left turns per delivery, above which the carrier may determine that it may offer scheduled delivery service for the consignee. Therefore, number of left turns rules may indicate that the carrier will offer scheduled delivery service for a delivery to the consignee delivery address in which the delivery vehicle may travel upon a delivery route to the consignee delivery address comprising a number of left turns that is greater than the threshold, whereas deliveries to addresses in which the number of left turns is not greater than the threshold may not qualify under this test for scheduled delivery service.

As can be appreciated by one of ordinary skill in the art, many other scheduled delivery service rules may be defined based on the historical delivery data or conditions, in accordance with embodiments of this invention. These rules may be used in a similar manner as the above-mentioned rules to determine whether scheduled delivery service is available for the consignee.

Once the carrier has determined the rules for determining whether to offer scheduled delivery service, the carrier may store the rules in the carrier memory device, which may include, for example, the carrier data storage device, the scheduled delivery service server, or other similar network entity (Block 864), which may be accessible by the scheduled delivery service server. The carrier may continually identify and determine rules, and the carrier may continually append, delete, substitute, and modify the rules stored in the carrier memory device. In Block 865, the scheduled delivery service server may access the rules that are stored in the carrier memory device, and in Block 866, the scheduled delivery service server may process the consignee order information, or information included in a consignee profile, against the rules to determine whether scheduled delivery service is available for the consignee, according to various embodiments of this invention. Order information that may be processed against the rules may include the consignee delivery address, the name of the consignee, the specific type of transaction, and whether the package is being shipped “signature required”, among other pieces of order information. As can be appreciated by one of ordinary skill in the art, many other pieces of order information may be processed against various rules in order to determine whether scheduled delivery service is available for the consignee. If the consignee delivery address, the name of the consignee, the specific type of transaction, or other piece of order information, fall within the rules accessed by the scheduled delivery service server, then the scheduled delivery service server may determine that scheduled delivery service is available for the consignee. Additionally, for example, if the package is being shipped “signature required”, then the scheduled delivery service server may determine that scheduled delivery service is available for the consignee. On the contrary, if the consignee delivery address, the name of the consignee, the specific type of transaction, or other piece of order information, does not fall within one or more of the rules accessed by the scheduled delivery service server, then the scheduled delivery service server may determine that scheduled delivery service is not available for the consignee under the rules being applied. Likewise, for example, if the package is not being shipped “signature required”, then the scheduled delivery service server may not determine that scheduled delivery service is available for the consignee. As can be appreciated by one of ordinary skill in the art, various other criteria and rules may be utilized by the carrier and/or the scheduled delivery service server to determine whether scheduled delivery service is available for the consignee.

Once the scheduled delivery service server has determined whether scheduled delivery service is available for the consignee, the scheduled delivery service process, according to various embodiments of this invention, returns to Block 870 in FIG. 8.

With reference to FIG. 11, FIG. 11 provides further detail of the time window determination process introduced in Block 890 in FIG. 8, in which the carrier may determine which time window(s) to provide to the consignor for which scheduled delivery service is available, based in part on data included in the order information, such as the consignee delivery address, or historical and/or current delivery data and/or conditions, among other factors. The process may begin when the scheduled delivery service server determines that scheduled delivery service is available for the consignee (Block 870).

As shown in Block 891, the carrier may receive historical and/or current delivery data and/or conditions. Using the historical and/or current delivery data and/or conditions, the carrier, in Block 892, may identify or determine various factors (“time window factors”) to assist in determining which time windows to provide to the consignor. The time window factors may include dispositive factors as to whether certain time windows may be offered or the factors may not be dispositive but may indicate that delivery during certain time windows is more or less difficult. In the latter embodiment (not shown), a difficulty flag may be stored in a carrier memory device, such as the carrier data storage device, the scheduled delivery service server, or other network entity, in association with a time window for the consignee order file. If more than one difficulty flag is stored in connection with any time window being considered for a consignee order file, the time window may not be offered for scheduled delivery service.

According to various embodiments of this invention, various time window factors related to current delivery conditions may include, but are not limited to, current traffic congestion in the area surrounding or leading to the consignee delivery address; the presence of traffic accidents in the area surrounding or leading to the consignee delivery address; current inclement weather conditions that may tend to make delivery more difficult during certain time windows; dignitaries scheduled to be visiting an area surrounding or leading to the consignee delivery address during certain time windows; announced road construction in the area surrounding or leading to the consignee delivery address during certain time windows; or other current conditions that may affect scheduled delivery to a consignee delivery address during certain time windows. As noted above, for any of the factors related to current delivery conditions, the factors may either be dispositive or the factors may indicate that delivery during certain time windows is more or less difficult. For example, in regard to the factor related to the presence of traffic accidents in the area surrounding or leading to the consignee delivery address during certain time windows, the carrier may not offer certain time windows if a traffic accident is impacting a route leading to the consignee delivery address during the certain time windows. However, instead of being a dispositive factor, the number of current traffic accidents may instead indicate that delivery during certain time windows is more difficult if the certain time windows are affected by current traffic accidents. In this case, a difficulty flag will be stored in connection with such time windows.

In accordance with other embodiments of this invention, various time window factors related to historical delivery data and/or conditions may include, but are not limited to, the historical frequency of deliveries during certain time windows to specific geographic areas, specific addresses, and to specific consignees; the historical frequency of traffic congestion in the area surrounding or leading to the consignee delivery address during certain time windows; the historical frequency of traffic accidents in the area surrounding or leading to the consignee delivery address during certain time windows; the historical frequency of occurrences of inclement weather that may tend to make scheduled delivery service more difficult during certain time windows; and other historical conditions that may affect scheduled delivery to a consignee delivery address during certain time windows. For any of the factors related to historical delivery data and/or conditions, the factors may either be dispositive or the factors may indicate that delivery during certain time windows is more or less difficult. In the latter embodiment (not shown), a difficulty flag may be stored in a carrier memory device, such as the carrier data storage device, the scheduled delivery service server, or other network entity, in association with a time window for the consignee order file. If more than one difficulty flag is stored in connection with any time window being considered for a consignee order file, the time window may not be offered for scheduled delivery service. For example, in regard to the factor related to the frequency of deliveries to specific geographic areas during certain time windows, the carrier may calculate or identify a threshold frequency of deliveries to specific geographic areas during certain time windows, above or below which the carrier may determine that it may offer the certain time windows to the consignor. However, instead of being a dispositive factor, the frequencies of deliveries to specific geographic during certain time windows areas may instead indicate that delivery during certain time windows is more difficult. In this case, a difficulty flag will be stored in connection with such time windows.

Furthermore, various embodiments of this invention may utilize yet other time window factors in determining which time windows to provide to the consignor. One factor may be the cost of scheduled delivery service to the consignee delivery address during certain time windows. The carrier may determine, for example, that certain time windows may not be provided to the consignor if the cost of scheduled delivery service during those certain time windows exceeds a threshold cost, which may be carrier-defined threshold. Accordingly, the scheduled delivery service server may or may not provide certain time windows to the consignor based on the cost of scheduled delivery service to the consignee delivery address. Another factor may relate to whether the consignee delivery address is near or on an existing carrier delivery route during certain time windows. This factor may be used in various manners by the carrier, in accordance with various embodiments of the present invention. In one embodiment, if the consignee delivery address is near or on an existing carrier delivery route during certain time windows, a carrier may wish to offer scheduled delivery service during those certain time windows in order to minimize delivery time. However, in other embodiments, if the consignee delivery address is not near or not on an existing carrier delivery route during certain time windows, a carrier may wish to offer scheduled delivery service during those certain time windows in order to ensure that a person is present at the consignee delivery address when the carrier delivers the package. Additional embodiments may utilize this factor in alternative manners.

Additionally, in even other embodiments, another time window factor may be related to whether the consignee is going to be present at the consignee delivery address at the time of a delivery for which the carrier must first obtain a signature before leaving the package at the consignee delivery address. As discussed above, the carrier must obtain a signature for deliveries to consignee delivery addressees that are located in areas designated by the carrier as “non-driver release areas” and for deliveries in which the shipment has been designated “signature required” by a party related to the shipment of the package. Thus, for deliveries in which the carrier must obtain a signature, the carrier may minimize the number of delivery attempts if the carrier knows that the consignee will be present at the consignee delivery address at the time of delivery. To determine whether the consignee may be present, the carrier may access a consignee profile that the consignee has provided to the carrier. The consignee may have provided profile information to the carrier via the carrier web site, telephone, email, or any other method in which the consignee may provide profile information to the carrier. The consignee profile may include, among other information, delivery times in which the consignee is not going to be present at the consignee delivery address to receive packages. These times may be referred to as consignee non-delivery time windows, and the carrier may not want to deliver packages to the consignee during the consignee non-delivery time windows if the carrier must first obtain a signature before leaving the package at the consignee delivery address. Accordingly, the scheduled delivery service server may not provide certain time windows to the consignee if the time windows correspond to consignee non-delivery time windows.

As can be appreciated by one of ordinary skill in the art, many other time window factors may be determined and identified based on the historical delivery data and delivery conditions, in accordance with various embodiments of this invention. These time window factors may be used in a similar manner as the above-mentioned factors to determine which time window(s) to provide to the consignor. Furthermore, one or more time window factors may be utilized in determining available time windows for a particular delivery.

The carrier may store the time window factors in the carrier memory device, which may include, without limitation, the carrier data storage device, the scheduled delivery service server, or other similar network entity (Block 893), which may be accessible by the scheduled delivery service server. The carrier may continually identify and determine time window factors, and the carrier may continually append, delete, substitute, and modify the time window factors stored in the data storage device. In Block 894, the scheduled delivery service server may access the time window factors stored in the carrier memory device, which may include, without limitation, the carrier data storage device, the scheduled delivery service server, or other similar network entity, and in Block 895, the scheduled delivery service server may process the consignee order information, which may include, for example, the consignee delivery address, or information included in a consignee profile against the time window factors to determine which time window(s) to provide to the consignor.

Once the scheduled delivery service server has determined which time window(s) to provide to the consignor, the scheduled delivery service process, according to various embodiments of this invention, returns to Block 900 in FIG. 9.

Furthermore, in accordance with alternative embodiments of the present invention in which the consignee may communicate the order directly to the carrier without a consignor as an intermediary, the process may be initiated when the consignee communicates an order to the carrier. The order may include at least a delivery address to where the consignee would like the carrier to deliver the package. The consignee, initiated through a consignee computer, may place the order on the Internet, among other methods, including via email, over the telephone (landline, mobile, satellite, or other type of telephone), via SMS, via catalog order, via postal service mail, through an in-store transaction, and via any other applicable method, according to various embodiments of the present invention. Once the consignee places the order, the carrier may receive the order information from the consignee by electronic data communication over a network and may store the order information as a consignee order file in a carrier memory device, such as the carrier data storage device, the scheduled delivery service server, or other network entity. In additional embodiments, the consignee may provide profile information to the carrier either in association with the order information or separate from the order information, and the consignee profile information may be stored by the carrier in a carrier memory device, such as the carrier data storage device, the scheduled delivery service server, or other network entity.

Next, the carrier may determine whether scheduled delivery service is available for the consignee. The determination may be based at least in part on various factors, including, for example, data included in the order information, such as the consignee delivery address, historical and/or current delivery data and/or conditions, or shipment-specific characteristics, among other factors. The process for making the determination is described in greater detail above in regard to FIG. 10. If the carrier determines that scheduled delivery service is not available, the carrier may notify the consignee by electronic data communication over a network that scheduled delivery service is not available and the carrier may deliver the package to the consignee without scheduled delivery service. If, however, the carrier determines that scheduled delivery service is available, the carrier may determine which time window(s) to provide to the consignee for which scheduled delivery service is available. The determination may be based at least in part on various factors, including, for example, data included in the order information, such as the consignee delivery address, or historical and/or current delivery data and/or conditions, among other factors. The process for determining the time windows to offer to the consignee is described greater detail above in regard to FIG. 11.

Upon determining which time window(s) to provide to the consignee, the carrier may provide the time window(s) to the consignee by electronic data communication over the network, and the consignee may provide a time window selection to the carrier by electronic data communication over the network, which the carrier may store in the carrier memory device, which may include, without limitation, the carrier data storage device, the scheduled delivery service server, or other similar network entity. Once the carrier receives the consignee time window selection, the carrier may deliver the package to the consignee via scheduled delivery service in accordance with the consignee time window selection.

The present disclosure is not limited solely to the shipping industry. Embodiments of this disclosure may be utilized in any scenario in which a logistics network may be optimized in order to increase efficiency, reduce costs, save time, or other related reasons. Examples may include the airline industry, railroad industry, and public transportation, among other related industries and businesses.

In addition, while the foregoing provides an example of the process by which the consignee may place an order, the carrier may determine whether to offer scheduled delivery service to the consignee, and the carrier may determine which time window(s) to offer for scheduled delivery service, the order described above of the steps performed in relation to that process is provided for exemplary purposes only and should not be taken in any way as limiting the scope of embodiments of the present invention to the order provided. Alternatively, as one of ordinary skill in the art will recognize in light of this disclosure, the foregoing steps may be performed in multiple different orders and combinations without departing from the spirit and scope of embodiments of the present invention.

Furthermore, as described above and as will be appreciated by one skilled in the art, embodiments of the present invention may be configured as a method or apparatus. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a programmable data processing apparatus, such as processor 510 discussed above with reference to FIG. 5, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus (e.g., processor 510 of FIG. 5) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. An apparatus comprising:
a processor configured to:
receive, by electronic data communication over a network, consignee order information from a consignee order file stored in a memory device, said consignee order information including at least a consignee delivery address;
retrieve, from a carrier data storage device, scheduled delivery service rules used to determine whether scheduled delivery service is available to a consignee delivery address; and
determine if scheduled delivery service is available to the consignee delivery address, based at least in part on one or more of the scheduled delivery service rules selected from the group consisting of frequency of failed delivery attempts rules; driver release rules; traffic congestion information rules; traffic accident rules; inclement weather rules; visiting dignitary rules; announced road construction rules; signature required rules; and number of left turns rules.

2. The apparatus of claim 1, wherein the scheduled delivery service rules relate to historical delivery data.

3. The apparatus of claim 1, wherein the scheduled delivery service rules relate to current delivery conditions.

4. The apparatus of claim 1, wherein scheduled delivery service is available to the consignee delivery address if a carrier's historical delivery data indicates that the area surrounding or leading to the consignee delivery address comprises an area that has a historical frequency of failed delivery attempts greater than a threshold frequency.

5. The apparatus of claim 1, wherein scheduled delivery service is available to the consignee delivery address if a carrier's historical delivery data indicates a historical frequency of failed delivery attempts to the consignee delivery address greater than a threshold frequency.

6-7. (canceled)

8. The apparatus of claim 1, wherein scheduled delivery service is available to the consignee delivery address if a carrier's historical delivery data indicates that the area surrounding or leading to the consignee delivery address comprises an area in which the carrier will leave a package at the consignee delivery address only if the carrier obtains a signature.

9. The apparatus of claim 1, wherein scheduled delivery service is available to the consignee delivery address if a carrier's historical delivery data indicates that the consignee delivery address comprises an address in which the carrier will leave a package at the consignee delivery address only if the carrier obtains a signature.

10-19. (canceled)

20. The apparatus of claim 1, wherein scheduled delivery service is available to the consignee delivery address if the shipment is designated signature required.

21. The apparatus of claim 1, wherein scheduled delivery service is available to the consignee delivery address if the current delivery allows a delivery vehicle to travel a delivery route to the consignee delivery address comprising a number of left turns greater than a threshold.

22. The apparatus from claim 1, wherein the processor is further configured to:
retrieve, from a carrier data storage device, upon determining that scheduled delivery service is available to the consignee delivery address, time window factors that are used to determine one or more time windows in which scheduled delivery service is available to the consignee delivery address;
determine one or more time windows in which the delivery can be scheduled, based at least in part on one or more of the time window factors selected from the group consisting of historical frequency of deliveries; traffic congestion information; traffic accidents; inclement weather; visiting dignitaries; announced road construction; and non-delivery time windows provided by the consignee to the carrier;
store, in the carrier data storage device, the one or more time windows in which the delivery can be scheduled;
provide to the consignor, by electronic data communication over a network, the one or more time windows in which the delivery can be scheduled;
receive an indication from the consignor, by electronic data communication over the network, said indication including a consignee selection of one of the one or more time windows; and
store, in the carrier data storage device, the consignee selection of one of the one or more time windows.

23. The apparatus of claim 22, wherein the one or more time windows provided to the consignee are based at least in part on the historical frequency of deliveries to the area surrounding or leading to the consignee delivery address during the one or more time windows.

24-34. (canceled)

35. The apparatus of claim 1, wherein the processor is further configured to provide one or more time windows for scheduled delivery to the consignee outside of non-delivery time windows provided by the consignee to the carrier.

36. The apparatus of claim 35, wherein the one or more time windows are provided to the consignee if the carrier must first obtain a signature before leaving the package at the consignee delivery address.

37. A method comprising:
receiving by an apparatus, by electronic data communication over a network, consignee order information from a consignee order file stored in a memory device, said consignee order information including at least a consignee delivery address;
retrieving by the apparatus, from a carrier data storage device, scheduled delivery service rules used to determine whether scheduled delivery service is available to a consignee delivery address; and
determining by the apparatus if scheduled delivery service is available to the consignee delivery address, based at least in part on one or more of the scheduled delivery service rules selected from the group consisting of frequency of failed delivery attempts rules; driver release rules; traffic congestion information rules; traffic accident rules; inclement weather rules;
visiting dignitary rules; announced road construction rules; signature required rules; and number of left turns rules.

38. The method of claim 37, wherein the scheduled delivery service rules relate to historical delivery data.

39. The method of claim 37, wherein the scheduled delivery service rules relate to current delivery conditions.

40. The method of claim 37, wherein scheduled delivery service is available to the consignee delivery address if a carrier's historical delivery data indicates that the area surrounding or leading to the consignee delivery address comprises an area that has a historical frequency of failed delivery attempts greater than a threshold frequency.

41-43. (canceled)

44. The method of claim 37, wherein scheduled delivery service is available to the consignee delivery address if a carrier's historical delivery data indicates that the area surrounding or leading to the consignee delivery address comprises an area in which the carrier will leave a package at the consignee delivery address only if the carrier obtains a signature.

45-57. (canceled)

58. The method of claim 37, further comprising:
retrieving by the apparatus, from a carrier data storage device, upon determining that scheduled delivery service is available to the consignee delivery address, time window factors that are used to determine one or more time windows in which scheduled delivery service is available to the consignee delivery address;
determining by the apparatus one or more time windows in which the delivery can be scheduled, based at least in part on one or more of the time window factors selected from the group consisting of historical frequency of deliveries; traffic congestion information; traffic accidents; inclement weather; visiting dignitaries; announced road construction; and non-delivery time windows provided by the consignee to the carrier;
storing by the apparatus, in the carrier data storage device, the one or more time windows in which the delivery can be scheduled;
providing by the apparatus to the consignor, by electronic data communication over a network, the one or more time windows in which the delivery can be scheduled;
receiving by the apparatus an indication from the consignor, by electronic data communication over the network, said indication including a consignee selection of one of the one or more time windows; and
storing by the apparatus, in the carrier data storage device, the consignee selection of one of the one or more time windows.

59. The method of claim 58, wherein the one or more time windows provided to the consignee are based at least in part on the historical frequency of deliveries to the area surrounding or leading to the consignee delivery address during the one or more time windows.

60-111. (canceled)

112. A system comprising:
a carrier device configured to:
receive, by electronic data communication over a network, consignee order information from a consignee order file stored in a memory device, said consignee order information including at least a consignee delivery address;
retrieve, from a carrier data storage device, scheduled delivery service rules used to determine whether scheduled delivery service is available to a consignee delivery address;
determine if scheduled delivery service is available to the consignee delivery address, based at least in part on one or more of the scheduled delivery service rules selected from the group consisting of frequency of failed delivery attempts rules; driver release rules; traffic congestion information rules; traffic accident rules; inclement weather rules; visiting dignitary rules; announced road construction rules; signature required rules; and number of left turns rules;
retrieve, from a carrier data storage device, upon determining that scheduled delivery service is available to the consignee delivery address, time window factors that are used to determine one or more time windows in which scheduled delivery service is available to the consignee delivery address;
determine one or more time windows in which the delivery can be scheduled, said one or more time windows based on the delivery having one or more characteristics selected from the group consisting of non-driver release area; high send again area; high traffic congestion area; high traffic accident area; high inclement weather area; shipment designated signature required; high left turn route; and consignee non-delivery time window;
store, in the carrier data storage device, the one or more time windows in which the delivery can be scheduled;
provide to the consignee, by electronic data communication over a network, the one or more time windows in which the delivery can be scheduled;
receive an indication from the consignee, by electronic data communication over the network, said indication including a consignee selection of one of the one or more time windows; and
store, in the carrier data storage device, the consignee selection of one of the one or more time windows.
